(19) United States
(12) Patent Application Publication
(10) Pub. No.: US 2012/0132623 A1
(43) Pub. Date: May 31, 2012

(54) ELECTRODE HOLDER

(76) Inventors: Jimmy Roger Justice, JR., Madisonville, KY (US); George Anthony Wells, Hanson, KY (US); Jeff Rodney Sumner, Madisonville, KY (US); Barry Joe Webb, Manitou, KY (US)

(21) Appl. No.: 13/303,718

(22) Filed: Nov. 23, 2011

Related U.S. Application Data
(60) Provisional application No. 61/418,114, filed on Nov. 30, 2010.

(51) Int. Cl. B23H 1/00

(52) U.S. Cl. 219/69.15

(57) ABSTRACT

An electrode holder having a replaceable guide through which an electrode extends longitudinally between an inner end operatively associated with an EDM machine and a free end engageable with a working surface of a component to be machined.

### CROSS-REFERENCE TO RELATED APPLICATION

This application claims priority to U.S. Provisional Application Ser. No. 61/418,114, filed Nov. 30, 2010, the disclosure of which is hereby incorporated in its entirety by reference herein.

### BACKGROUND OF THE INVENTION

The technology described herein relates generally to electrode holders of the type used for electrical discharge machining (EDM).

EDM machining is basically; controlling an electrical charge transmitted through a conductive media (electrodes) such as graphite, brass, copper, or tungsten to perform a metal/material removal operation to a specific shape or form. Sinker type EDM operations use generally copper or graphite electrodes and are submerged in a dielectric oil solution (petroleum base) that cools and cleans the area being machined. These sinker electrodes are normally a shaped form created by a grind, stamping, or general machine operation and done to the customer's specifications, these electrodes are use in the sinker machines to create geometries not easily or cost effectively created by conventional machining. The electrodes are normally stationary and do not rotate or move, thus allowing formed shapes to be created. In most cases the electrodes are a one or two time use item before they have to be dressed and reshaped or replaced.

Hole drilling EDMs are done in a D.I. water system. Electrodes are generally brass or copper and are extruded/drawn into a circular form. These round, job specific diameter electrodes are placed into a holder of some type and directed to a predefined spot or location. The controlled electric discharge is initiated and the electrode is fed into the work piece to create a round hole varying in size and depth based on customer/design requirements. The electrodes in fast hole drilling operation generally are spinning (program controlled) and also have high pressure thru electrode flushing, this is used to remove waste material created by the discharge process. After the hole is “EDM drilled” the electrode is retracted and moves on to the next location and steps are repeated until the electrode has insufficient length to create another hole. Some EDM controllable parameters include amperage, on and off time, voltage, capacitance, feed rate, water pressure, etc.

Many manufacturing operations, such as those used to manufacture gas turbine engine components, require drilling non-line-of-sight (NLS), reverse angle NLS (RNLS), blind, and through holes in small pockets or cavities. Currently available EDM manufacturing techniques rely upon standard copper, single-use electrodes running in oil or electro-stream (ES) drilling with a bent pipette. Both of these methods are expensive and are not capable of fine EDM work in small cavities.

Therefore, there remains a need for improved electrode holders for fine EDM work in small pockets or cavities which are cost-effective yet provide the needed capabilities.

### BRIEF DESCRIPTION OF THE INVENTION

In one aspect, an electrode holder having a replaceable guide through which an electrode extends longitudinally between an inner end operatively associated with an EDM machine and a free end engageable with a working surface of a component to be machined.

### BRIEF DESCRIPTION OF THE DRAWINGS

FIG. 1 is a cross-sectional illustration of an exemplary electrode holder;

FIG. 2 is a cross-sectional illustration of another embodiment of an electrode holder; and

FIG. 3 is a perspective view of the electrode holder of FIG. 1 in operation.

### DETAILED DESCRIPTION OF THE INVENTION

FIG. 1 is a cross-sectional illustration of an exemplary electrode holder 10 having a guide body 12, guide shank 14, guide nose clamp 16, and guide nose 18. An electrode 20 extends longitudinally through the guide body 12, guide shank 14, and guide nose 18 to a free end 22 which performs the machining operation. Inner end 24 is operatively connected to the EDM machine (not shown).

Guide shank 14 is pressed or otherwise secured into the guide body 12. Guide nose clamp 16 is removeably secured to the guide shank 14, such as by mating threads. Guide nose clamp 16 provides support for the guide nose 18 and secures it within the guide shank 14 and guide body 12, such as by a collet type arrangement.

Guide body 12 includes a central cavity 30 and an aperture 32 through which a low pressure supply of lubricant 34 is introduced. This low pressure lubricant 34 fills cavity 30 and the hollow interior of guide nose 18, flowing outwardly toward a workpiece (not shown) in the form of lubricant streams 36.

In the embodiment of FIG. 1, the electrode 20 is hollow and receives a high pressure supply of lubricant 40 in the form of a stream 42 which is introduced into the inner end 24 and flows outwardly toward a workpiece (not shown) in the form of lubricant stream 44. In the embodiment described herein, low pressure lubricant 34 is at a comparatively lower operating pressure than high pressure lubricant 40.

Low pressure lubricant 34 surrounds the electrode 20, thereby aiding the relative sliding motion of the electrode 20 as it feeds through the guide nose 18 and also serving to flush any debris away from the working surface and from the interface between the electrode 20 and the guide nose 18. High pressure lubricant 40 also serves to flush debris away from the working surface during the EDM operation.

The guide nose 18 is a replaceable section of tubing which can be changed as necessary due to wear or damage by unscrewing the guide nose clamp 16, removing the worn guide nose 18, replacing it with a new guide nose 18, and tightening down the guide nose clamp 16. The guide nose 18 can be replaced numerous times using the same guide body 12, guide shank 14, and guide nose clamp 16. This permits a variety of guide nose lengths, diameters, and configurations to be used with the same guide body and guide shank, and the electrode can be fed continuously through the guide nose for replenishment and held by the guide nose in the appropriate orientation for the operation to be performed.

In the embodiment shown in FIG. 1, the guide nose 18 is curved such that the free end 22 of the electrode 20 is oriented approximately 90 degrees to the axis of the guide body 12, such as to permit access to a small or closely confined work area. This curvature may be a comparatively tight radius due to the slender nature of the guide nose 18 and the electrode 20.

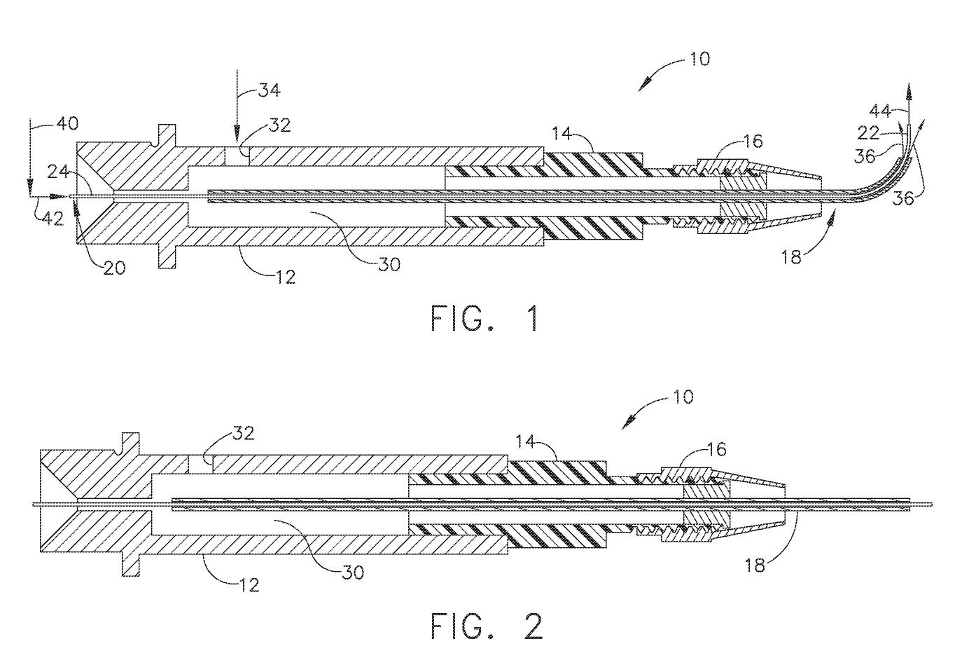

FIG. 2 is a cross-sectional illustration of another embodiment of an electrode holder 10, wherein the guide nose 18 extends outwardly from the guide nose clamp 16 in a straight line. Like elements are identified with like reference numerals as shown in FIG. 1. Such an embodiment may be useful in situations where space near the working surface is less confined or which permits more direct access along the axis of the guide body 12.

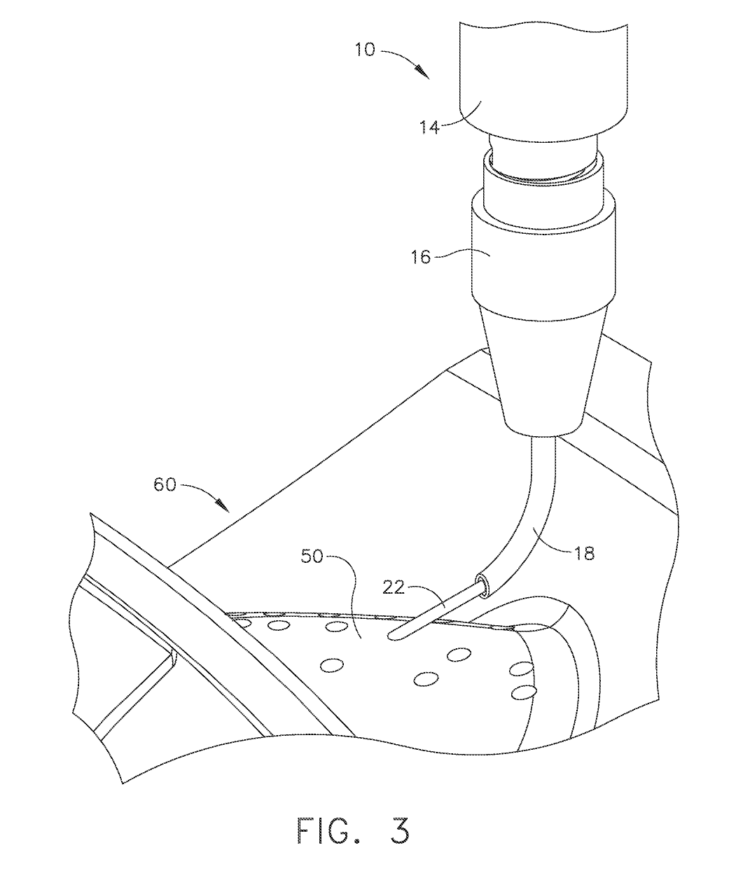

In FIG. 3, the electrode holder 10 of FIG. 1 is shown in a perspective view performing an operation on a working surface 50 of a component 60, which may be a component of a gas turbine engine such as a nozzle.

The elements of the electrode holder 10 may be fabricated from any suitable materials and be configured in any suitable configuration. Comparatively tight radius (such as 0.250 R) bends may be made in the guide nose to permit work in confined areas. For example, the guide nose may be fabricated from stainless steel and the electrode may be fabricated from brass, while the guide body, guide shank, guide nose, and guide nose clamp may be fabricated from non-metallic materials such as polymeric materials or composites. The electrode may be of an extended length continuously fed from a supply or may be a discrete length replaceable in sections, in either event fed through the guide body and exposing a free end proximal to the working surface.

While the invention has been described in terms of various specific embodiments, those skilled in the art will recognize that the invention can be practiced with modification within the spirit and scope of the claims.

What is claimed is:

1. An electrode holder, said electrode holder comprising:
a replaceable guide; and
an electrode, said electrode having an inner end and a free end;
wherein said electrode extends longitudinally through said guide between said inner end which is operatively associated with an electrical discharge machining (EDM) machine and said free end which is engageable with a working surface of a component to be machined.

2. An electrode holder in accordance with claim 1, wherein said electrode is hollow.

3. An electrode holder in accordance with claim 2, wherein said electrode receives a high pressure supply of lubricant which is introduced into said inner end and flows outwardly toward a workpiece.

4. An electrode holder in accordance with claim 1, wherein said replaceable guide is a replaceable section of tubing.

5. An electrode holder in accordance with claim 1, wherein said replaceable guide is curved.

6. An electrode holder in accordance with claim 1, wherein said replaceable guide is straight.

7. An electrode holder in accordance with claim 1, wherein said electrode is a discrete length.

8. An electrode holder in accordance with claim 1, wherein said electrode is an extended length continuously fed from a supply.

9. An electrode holder in accordance with claim 1, wherein said free end extends beyond said guide.

10. An electrode holder, said electrode holder comprising:
a replaceable guide formed of a replaceable curved section of tubing; and
a hollow electrode, said electrode having an inner end and a free end;
wherein said electrode receives a high pressure supply of lubricant which is introduced into said inner end and flows outwardly toward a workpiece; and
wherein said electrode extends longitudinally through said guide between said inner end which is operatively associated with an electrical discharge machining (EDM) machine and said free end which is engageable with a working surface of a component to be machined.
